(19) United States
(12) Patent Application Publication
(10) Pub. No.: US 2017/0318088 A1
(43) Pub. Date: Nov. 2, 2017

(54) EFFICIENT FILE SYNCHRONISATION

(71) Applicant: LiveQoS Inc., Ottawa (CA)

(72) Inventors: Stephane Brunet, Ottawa (CA); Maged Alhagri, Ottawa (CA); Martin William Horne, Woodlawn (CA); Miika Anttoni Klemetti, Kanata (CA)

(21) Appl. No.: 15/141,165

(22) Filed: Apr. 28, 2016

(51) Int. Cl. H04L 29/08

(52) U.S. Cl. CPC H04L 67/1095; H04L 67/06

(57) ABSTRACT

A method for efficiently synchronizing a file between a first node and one or more second nodes, each of which is configured with an initial file. The method comprises applying at the first node one or more first transforms to the file; preparing a descriptor of the one or more first transforms applied to the file; transmitting the descriptor to the one or more second nodes; decoding the descriptor to extract one or more second transforms at the one or more second nodes; and executing the one or more second transforms on the initial file located to obtain a semantically equivalent file at the one or more second nodes. The one or more second transforms may be identical to or different from the one or more first transforms. The initial file configured on the first and second nodes may be binary equivalent or semantically equivalent.

### FIELD OF THE INVENTION

The present disclosure relates to efficient synchronization transmission of files.

### BRIEF SUMMARY

In accordance with one embodiment, a method is provided for efficiently synchronizing a file between a first node and one or more second nodes, each of which is configured with an initial file. The method comprises applying at the first node one or more first transforms to the file; preparing a descriptor of the one or more first transforms applied to the file; transmitting the descriptor to the one or more second nodes; decoding the descriptor to extract one or more second transforms at the one or more second nodes; and executing the one or more second transforms on the initial file located to obtain a semantically equivalent file at the one or more second nodes. In one implementation, the one or more second transforms are identical to the one or more first transforms. In another implementation, the one or more second transforms are different from the one or more first transforms. The initial files configured on the first and second nodes may be binary equivalent or semantically equivalent. The initial files may be video files or media files.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a diagrammatic illustration of a prior art system for synchronizing a file between first and second nodes.

FIG. 2 is a diagrammatic illustration of one embodiment of an exemplary method for synchronizing a file between first and second nodes with improved efficiency.

FIG. 3 is a diagrammatic illustration of a method of codifying the descriptor in the method of FIG. 2.

FIG. 4 is a diagrammatic illustration of a method of decoding the descriptor and creating a semantically equivalent video in the method of FIG. 2.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Companies that create videos, such as motion picture, interactive and digital media, corporate and training, 3D animation, etc., face the challenge of team collaboration throughout the entire production and post production processes. Often these teams are highly specialized and globally distributed. On top of this geographical challenge is that video file sizes are getting much larger as 4K and 6K video formats are becoming more widely adopted.

Given the dramatic increase in creation of videos and the growing size of these video files on the internet, and considering the collaborative nature of video production and post-production involving participants worldwide that impose on systems and networks, this claim describes the use of semantic equivalence (as opposed to binary equivalence) as the mechanism for video file synchronization.

The specification presents the embodiments in the context of efficient synchronization of a video file, but it should be understood by someone skilled in the art that the embodiment can be applied to synchronization of any type of large files.

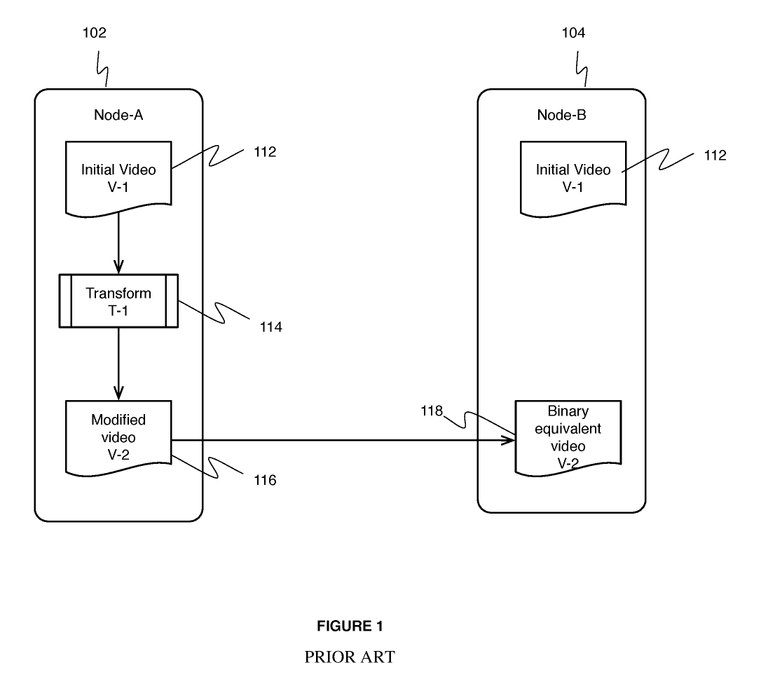

In the existing art, referring to FIG. 1, two users are remotely located at node A 102 and node B 104 respectively. Nodes can be computing engines, workstations, applications etc. One user 102 possesses the original video V-1 112. The system or user at node A 102 transforms video V-1 using transformation T-1 114 to create video V-2 116. Transformation T-1 114 may be, for example, cutting or adding a scene, adding an audio track, applying a fade-in/out effect or color effect across video frames, applying or changing an overlay to one or more video frames, editing of the video metadata, etc. Once transformation T-1 has been processed by Node A 102, the entire video V-2 is sent to Node B 104 which stores V-2 118 for processing/editing. The video size can be very large (e.g. giga or tera bytes).

Two or more video files are binary-equivalent if they have exact same content at the binary level. Two or more video files are semantically-equivalent if they share audio, video and overlay content at corresponding time indices.

Video files do not necessarily require binary equivalence to be considered semantically equivalent by the observer. Slight differences may go unnoticed by both a casual observer and a skilled observer, and/or may not impact the observer's experience, subject to the level of semantic equivalence required or imposed by the application or system. Examples of semantically equivalent videos include two identical videos that are encoded using different CODECs (e.g., VP-8 or H.264), or encoded using the same CODEC but differing in terms of the binary size, or simply stated, differing in terms of their binary structure.

In one embodiment, video file synchronization between one or more nodes can be performed via synchronization by semantic equivalence, in order to achieve various system and/or user-experience goals. Such goals might include, for example:
Improved processing efficiency required to achieve data synchronization;
Improved efficiency in the amount of data transferred or the amount time required to transfer data;
Improved work flow efficiency;
Improved cost efficiency;
Increased opportunity and/or improved experience for the system(s) or the user(s)

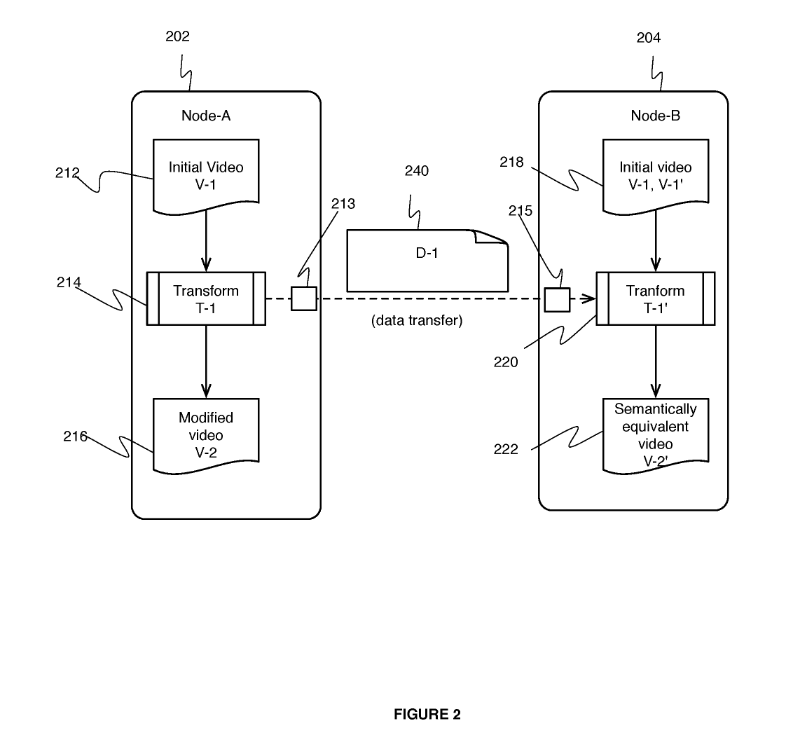

As shown in FIG. 2 below depicts first and second nodes 202, 204 as per FIG. 1 who intend to synchronize changes applied to a video file V-1 212.

Both nodes initially possess either a binary-identical version 212, 218 (copies of V-1), or semantically equivalent versions of V-1, labelled V-1′ 218.

The system or user at Node A (first node) transforms video V-1 using transformation T-1 214. Transformation T-1 214 may be, for example, cutting or adding a scene, adding an audio track, applying a fade-in/out effect or color effect across video frames, applying or changing an overlay to one or more video frames, editing of the video metadata, etc.

The transformation T-1 processed by Node A results in video V-2 216 being stored on Node A. Node A now wants to synchronize V-2 with Node B (second node). In this embodiment, a semantic-difference descriptor D-1 240 is constructed by a software module 213 located on Node A. The descriptor D-1 240 is then sent to a compatible software module 215 located on Node B which decodes the descriptor D-1 to create a transform T-1′ to apply on the video V-1 or V-1′ 218 stored on Node B.

D-1 240 contains the required data, metadata (information about the data) as well as any required system-level information (possibly including information about V-1′ 218 on Node B), to accomplish transformation now referred to as T-1′ 220 by Node B on video V-1 (or V-1′) 218, such that the resulting video V-2′ 222 represents a semantically equivalent version of video V-2 216.

Descriptor D-1 240 may be constructed using information solely available on Node A, or may be constructed using information available on Node B (via in band or out of band communication), or from information available from a third party, as determined by the requirements of the system. It should be understood by someone skilled in the art that the first node may synchronize the video with two or more second nodes.

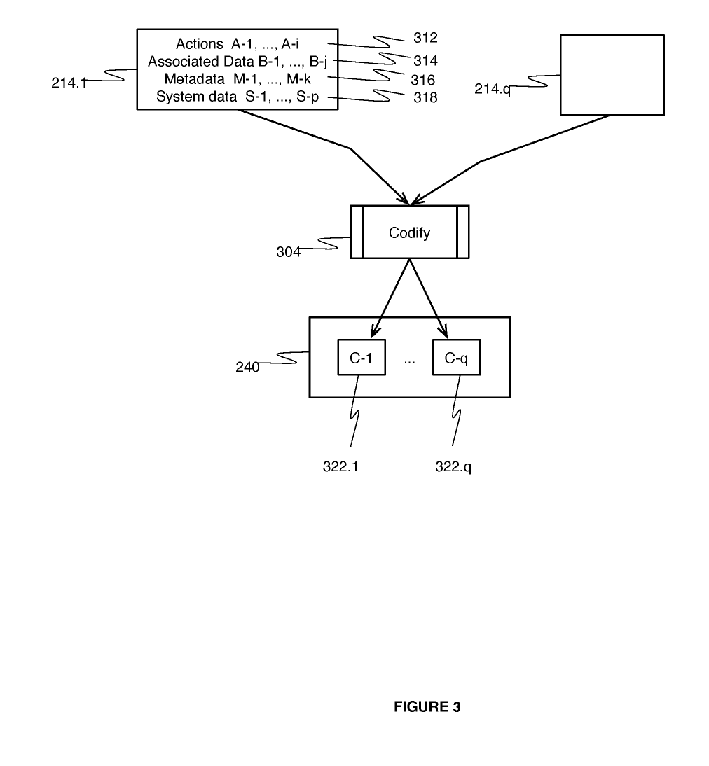

As shown in FIG. 3, each transformation T-1 214.1 . . . 214.q comprises one or more actions A-1 . . . A-i 312, one or more associated data 314, one or more metadata 316 and one or more system data 318. The module 213 codifies 304 each transformation 214.1 . . . 214.q to create one or more codified representation C-1 . . . C-q 322.1 . . . 322.q of each T-1 214.1 . . . 214.q which can optionally be concatenated into one descriptor D-1 240 to be applied at the other node or sent as separate descriptors.

D-1 therefore consists of one or more of the following: One or more codified representations of one or more actions to take (each action may be represented using one or more expressions of said action), a codified representation of a recommended or required, chronological order of, the application of said actions, time indices and/or time intervals, relative to video V-1 (or V-1′), or relative to the intermediate result of a previously applied action, required to apply the current action, associated data required to perform each action, including added media content, metadata, or external data required to perform or validate the action.

D-1 may include added content, or external data required to achieve an effect of some kind. D-1 may also contain any other information required to achieve semantic equivalence between video V-2 and video V-2′.

The descriptor D-1 may optionally contain a reference to video V-1 (or V-1′). The descriptor D-1 may also contain a data payload required to achieve transformation T-1 (or T-1′).

The codification can be done using any known techniques of codification known in the art.

The difference descriptor D-1 240 is transmitted from Node A to Node B, incrementally or as a whole, via memory, storage device, inter-process communication, digital communication channel, network connectivity, or any other means of communication available, as determined appropriate by the system and its requirements. Since the size of D-1 is smaller than the entire video, the increased performance and efficiency goals are achieved.

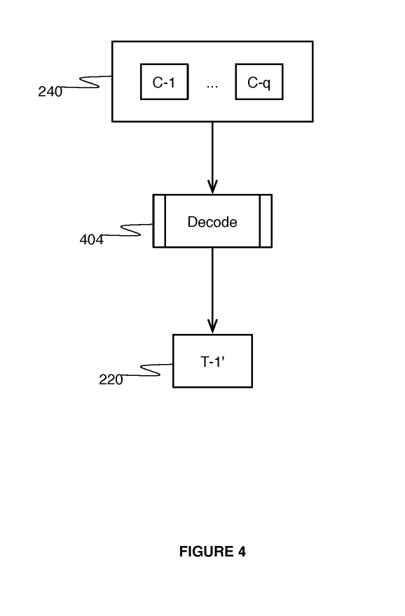

FIG. 4 shows the flow of decoding the descriptor and creating the semantically equivalent video. Upon Node B obtaining descriptor D-1 240, Node B proceeds with decoding 404 the descriptor D-1 240 to create the transformation T-1′ 220. Node B applies the transformation T-1′ until V-2′ 222, a semantically equivalent version of video V-2 216, is generated. T-1′ 220 may be identical to T-1 214, or T-1′ 220 may comprise of a variation of T-1 214 which, when applied to video V-1 (or V-1′) 218, will result in a video V-2′ 222 being semantically equivalent to video V-2 216.

Although the description of the embodiment uses only one node as an example, the embodiment can be extended to synchronize between a first node and a plurality of other nodes.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method for efficiently synchronizing a file between a first node and one or more second nodes each configured with an initial file comprising:
applying at the first node one or more first transforms to the file;
preparing a descriptor of the one or more first transforms applied to the file;
transmitting the descriptor to the one or more second nodes;
decoding the descriptor to extract one or more second transforms at said one or more second nodes; and
executing the one or more second transform on said initial file located to obtain a semantically equivalent file at the one or more second node.

2. The method of claim 1 wherein said one or more second transforms are identical to said one or more first transforms.

3. The method of claim 1 wherein said one or more second transforms are different to said one or more first transforms.

4. The method of claim 1 wherein said initial files configured on the first and second nodes are binary equivalent.

5. The method of claim 1 wherein said initial files configured on the first and second nodes are semantically equivalent.

6. The method of claim 1 wherein said initial file is a video file.

7. The method of claim 1 wherein said initial file is a media file.
